(19) United States
(12) Patent Application Publication
(10) Pub. No.: US 2026/0037942 A1
(43) Pub. Date: Feb. 5, 2026

(54) AUTOMATED SOFTWARE FOR ADVANCED EXECUTION OF RESOURCE-RELATED JOBS

(71) Applicant: SAP SE, Walldorf (DE)

(72) Inventors: Ramanujam Duraisamy, Bangalore (IN); Ambarish S, Bangalore (IN); Vallisha Prasad, St. Leon-Rot (DE); Vijaya Kumar Yekbote, Bangalore (IN); Kamalesh Kumar P R, Bangalore (IN); Sanju Joseph, Bangalore (IN); Rupesh Kumar Tripuramallu, Bangalore (IN); Anubhuti Kumari, Bangalore (IN); Taity Banerjee, Bangalore (IN); Saurabh Kejriwal, Bangalore (IN); Suhas Nagaraj, Bangalore (IN); Archana MS, Bangalore (IN); Michael Schafft, Hassloch (DE); Pranoti Sheshrao Chankapure, Bangalore (IN); Shiva Prasad Karnekanti, Bangalore (IN)

(21) Appl. No.: 18/790,157

(22) Filed: Jul. 31, 2024

(51) Int. Cl. G06Q 20/10; G06Q 20/40; G06Q 30/0207

(52) U.S. Cl. CPC G06Q 20/102; G06Q 20/4016; G06Q 30/0207

(57) ABSTRACT

A request is received, via a first user interface, to determine a billing value for a first service order. In response to receiving the request, a resource-related billing value associated with the first service order is generated, where the resource-related billing value combines a plurality of value components and a plurality of adjustments. Also, a financial risk value is generated based on the resource-related billing value. Next, a financial risk assessment is generated based on the financial risk value. Then, the financial risk assessment and the resource-related billing value are displayed in the first user interface. Additionally, one or more actions are automatically performed based on the financial risk assessment. These actions may include automatically rejecting the first service order responsive to the financial risk assessment being greater than a threshold.

### TECHNICAL FIELD

The present disclosure generally relates to automating resource related processes with advanced execution using software applications.

### BACKGROUND

It can be challenging to deal with the uncertainty and complexities of managing, performing, and charging for maintenance work, especially in the context of repairing items such as cars, engines, compressors, pumps, turbines, and the like. The lack of a clear scope of repair, difficulties in planning, and finding skilled workers make it difficult to agree on pricing upfront for these types of service jobs. The resource-intensive nature of the repair process and the spread of expenses over time makes it hard to effectively manage and bill for the job. Additionally, customer-specific services without fixed prices create challenges in determining the appropriate billing principles. These issues are further complicated in scenarios like make-to-order production, external plant maintenance, and specific services like consulting.

### SUMMARY

In some implementations, a request is received, via a first user interface, to determine a billing value for a first service order. In response to receiving the request, a resource-related billing value associated with the first service order is generated, where the resource-related billing value combines a plurality of value components and a plurality of adjustments. Also, a financial risk value is generated based on the resource-related billing value. Next, a financial risk assessment is generated based on the financial risk value. Then, the financial risk assessment and the resource-related billing value are displayed in the first user interface. Additionally, one or more actions are automatically performed based on the financial risk assessment. These actions may include automatically rejecting the first service order responsive to the financial risk assessment being greater than a threshold.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of a system, in accordance with some example implementations of the current subject matter;

FIG. 2 illustrates a diagram of a process flow for a resource related billing and advanced execution service application, in accordance with some example implementations of the current subject matter;

FIG. 3 illustrates a diagram of an advanced execution flow, in accordance with some example implementations of the current subject matter;

FIG. 4 illustrates examples of resource-related billing service with advanced execution graphical user interfaces, in accordance with some example implementations of the current subject matter;

FIG. 5 illustrates an example of a process for employing a resource related billing advanced execution service, in accordance with some example implementations of the current subject matter;

FIG. 6 illustrates an example of a process for generating multiple risk exposure assessments, in accordance with some example implementations of the current subject matter;

FIG. 7 illustrates an example of a process for carrying forward a service agreement, in accordance with some example implementations of the current subject matter;

FIG. 8 illustrates an example of a process for returning residual value after completing a job, in accordance with some example implementations of the current subject matter;

FIG. 9 illustrates an example of a process for fulfilling a job request with a flexible scope of service work, in accordance with some example implementations of the current subject matter;

FIG. 10 illustrates an example of a process for updating a financial risk value when performing a service job order, in accordance with some example implementations of the current subject matter;

FIG. 11 illustrates an example of a process for performing the scope of work under the third line item of a service job order, in accordance with some example implementations of the current subject matter;

FIG. 12 illustrates an example of a process for moving a financial risk value to a new category, in accordance with some example implementations of the current subject matter;

FIG. 13 illustrates an example of a process for executing a resource-related billing service job order, in accordance with some example implementations of the current subject matter;

FIG. 14 illustrates an example of a process for processing a resource-related service order, in accordance with some example implementations of the current subject matter;

FIG. 15A depicts an example of a system, in accordance with some example implementations of the current subject matter; and

FIG. 15B depicts another example of a system, in accordance with some example implementations of the current subject matter.

### DETAILED DESCRIPTION

There are service jobs that are not really amenable for an upfront fixed price commitment to the customer. Medium and complex external plant maintenance jobs are planned and executed over a period of time with varied planning, execution uncertainties, and significant resource consumption. And these consumptions cannot be well predicted ahead of time.

Accordingly, there is a need for more efficient and effective billing process tools for chargeable maintenance works, especially for resource-related billing in complex service jobs. These tools may be put into use across industries in a variety of different end-use cases and processes. These tools allow for financial risk to be managed effectively while also providing accurate billing. These tools are useful for meeting consumption-based billing requirements. Consumption-based billing may also be referred to as resource-related billing. Accordingly, the terms “consumption-based billing” and “resource-related billing” may be used interchangeably herein.

Service jobs require timely, accurate collection of cost as per the resources consumed (e.g., labor, material, expenses of varied nature) during execution and charging of the customer based on consumption. The individual components of these resources consumed can have an agreed-upon price. This service provider business requirement in different complexities is supported by resource related billing process in the service process with advanced execution variant. In the end-to-end process, this resource related billing value is also considered to accurately update the financial risk as per automated process flow in the credit management solution.

An Advanced Execution Service process may be integrated in a database system such as SAP Hana as available from SAP SE, Walldorf, Germany. The Advanced Execution Service process is designed to cater to the needs of medium or high complexity asset-centric service providers by providing accurate tracking of costs. The Advanced Execution Service process may offer various billing options, including fixed price agreements or charging customers based on the resources consumed for the job. To handle these different billing requirements, multiple solution components may be utilized. This allows for flexibility in determining how expenses incurred during service execution are accounted for, whether it be through inhouse or external resource deployment. The key billing solution capability of the service job is to provide the ability to charge customers based on factors such as price, discounts, special uplift master data, or manually updated details as agreed in individual service agreements or long-term service agreements. The service manager needs the ability to account for the various costs associated with the job and make decisions on what to charge the customer based on agreed-upon prices, uplifts, and discounts. The Advanced Execution Service process is able to meet the diverse requirements of complex asset maintenance service offerings.

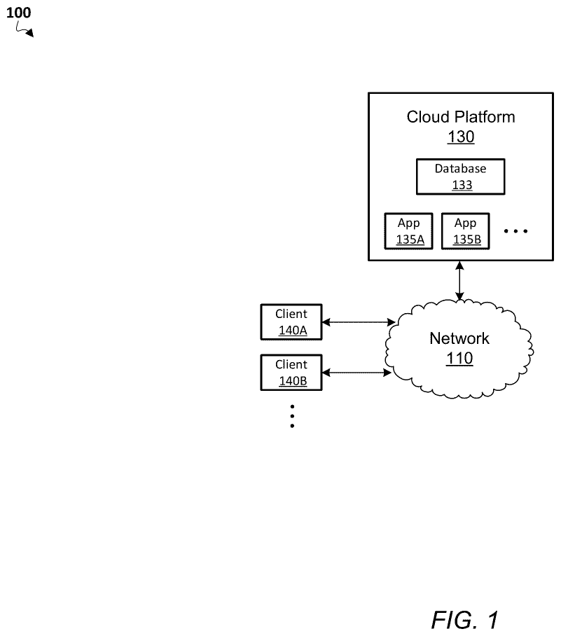

FIG. 1 depicts a diagram illustrating an example of a system 100 consistent with implementations of the current subject matter. Referring to FIG. 1, the system 100 may include a cloud platform 130. The cloud platform 130 may provide resources that can be shared among a plurality of tenants. For example, the cloud platform 130 may be configured to provide a variety of services including, for example, software-as-a-service (SaaS), platform-as-a-service (PaaS), infrastructure as a service (IaaS), and/or the like, and these services can be accessed by one or more tenants of the cloud platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of the particular customers to access a given cloud service having shared resources via the Internet and/or other type of network 110 or communication link(s).

The cloud platform 130 may include resources, such as at least one computer (e.g., a server), data storage, and a network (including network equipment) that couples the computer(s) and storage. The cloud platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform 130 may be a “private” cloud platform, in which case the resources of the cloud platform 130 may be hosted on an entity's own private servers (e.g., dedicated corporate servers operated and/or owned by the entity). Alternatively, or additionally, the cloud platform 130 may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In various embodiments, the cloud platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer).

In the example of FIG. 1, there is one database 133, although other quantities of databases may be implemented as well. The database 133 is internal to the cloud platform 130, but other databases external to the cloud platform 130 may be employed in some embodiments. To illustrate further, the client 140A may cause execution of a process or job on application 135A or application 135B. Applications 135A-B are representative of any number and type of applications running on cloud platform 130. In an example, application 135A may be a resource related billing and advanced execution service application. In this example, application 135A may consider the planning and execution capabilities of maintenance orders in the Advanced Execution Service. Also, application 135A may build the logic to address the source data that needs to be considered for billing request creation. Application 135A may also generate a financial risk update for each job that is being monitored. The financial risk update may be based on an accurate consumption-based service billing value. The generation of the billing value may rely on a variety of process variants such as individual price agreements for the job and a service agreement which the customer has signed with the service provider.

In an example, the current subject matter involves continuous financial risk evaluation and risk value update in the end-to-end order processing at various stages of order processing with the risk getting cleared out finally with the incoming payment receipt. The order processing can be based on an individual agreement with (a) standard price master, uplift, discounts; and (b) individually agreed price master, uplift, discounts for that transaction. These components reflect the initial order value which need not be finally invoiced value. The order processing with respect to a service agreement can be (c) contract based price agreement price and discounts; and (d) Individually agreed price master, uplift, discounts for that transaction. These components reflect the initial order value which need not be finally invoiced value. To begin with, financial risk under the category of order will be updated for the above variants automatically with initial order value set up above.

During the execution phase the agreement may allow multiple billing and invoicing of the customer based on the resources that are consumed. The resource-related billing capability enables billing request creation automatically considering the agreements like price or discount agreed at the beginning based on the actual usage of resources. For complex customer maintenance jobs, an authorised business user may moderate if the entire cost or most of the incurred cost for the job should be considered for billing request generation. As the value flow from actual cost to billing request value are tightly integrated based on well-defined software logic and customer configuration, the accurate billing request value will automatically be updated under a new financial risk category adjusting the preceding risk category automatically. The solution will allow billing request value changes for authorised business users, and these changes will be automatically reflected in financial risk update.

At the next stage of order processing, invoicing will be performed and the financial risk exposure will automatically be updated under a new financial risk category while adjusting the preceding risk category. On completion of billing, any residual financial risk value on the preceding categories (e.g., order, billing request) will be removed and the risk value will stay under the invoiced category. This risk value will eventually be cleared once the customer makes a payment against the invoice.

Various highlights of the solutions based on the current subject matter include (1) Value flows driven by business master data and transactions manually intervened by authorised users being automatically considered by the resource related billing solution and financial risk update solution. Value updates are automatically aligned to the processing of transaction, in real time and accurately; (2) Reconciliation requirements should be an exception; (3) Individual agreements at the start of the order are considered and reflected accurately in the billing request creation stage, ensuring accuracy of automated financial risk update; and (4) The design will recognise residual financial risk under different categories and remove the individual risk categories through a validation process. In general, the solutions offer extensibility with business specific logic for billable value and risk value update. More details on the operation of a resource related billing and advanced execution service application to manage financial risk and generate accurate billing invoices will be provided throughout the remainder of this disclosure.

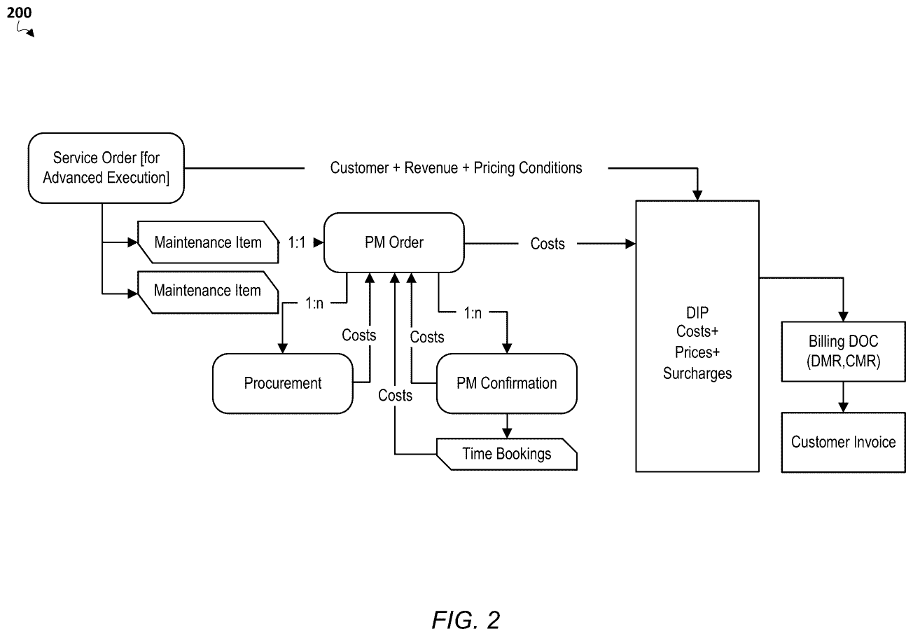

Turning now to FIG. 2, a diagram of a process flow 200 for a resource related billing and advanced execution service application is shown, consistent with implementations of the current subject matter. A service order for advanced execution may be initiated and managed by a resource related billing and advanced execution service application. The service order may specify any number of line items. A planned maintenance (PM) order may be generated based on one or more of the line items. For the PM order, a procurement engine may be queried to determine the costs associated with the various maintenance items. Also, the costs associated with time bookings may be determined and used to calculate the total cost of the PM order.

The data associated with the service order and the PM order are provided as inputs to a dynamic item processor (DIP). In an example, the customer, revenue, and pricing conditions are extracted from the service order by the dynamic item processor. Also, the costs are extracted from the service order by the dynamic item processor. The dynamic item processor calculates the costs, prices, and surcharges based on the data extracted from the customer maintenance order and the PM order. In an example, the dynamic item processor reads expense data and resource consumption data from a source table. The fields of the source table may be read as characteristics and the field contents as characteristics values. These characteristics values are customized using margins, uplifts, discounts and so on. A billing document may be generated based on the calculated costs, prices, and surcharges, and then a customer invoice may be generated based on the billing document. It should be understood that the process flow 200 is merely indicative of one particular process flow for a resource related billing and advanced execution service application. In other embodiments, other types of process flows may be organized in other suitable manners for resource related billing and advanced execution service applications.

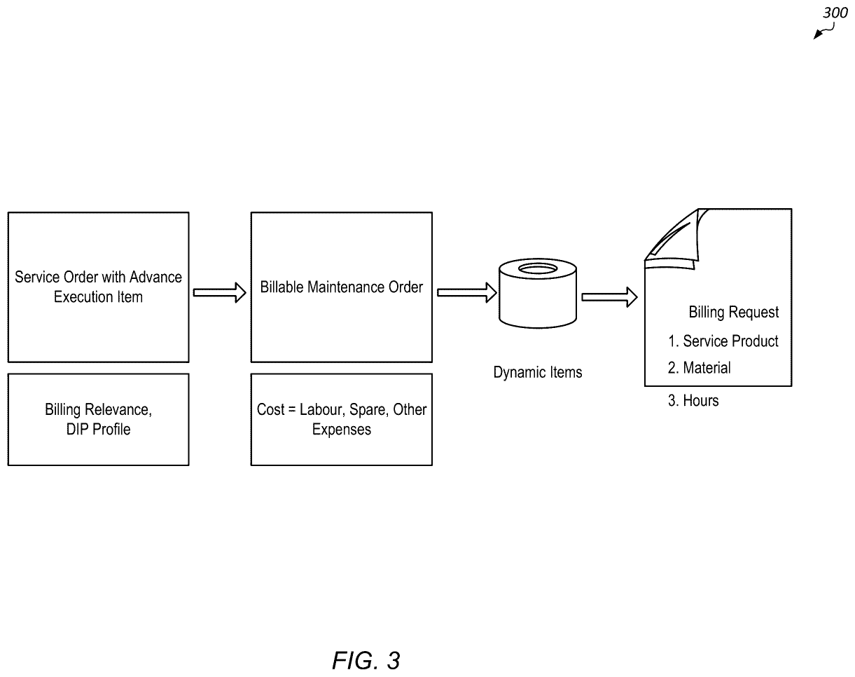

Referring now to FIG. 3, a diagram of an advanced execution flow 300 for a service order is shown, consistent with implementations of the current subject matter. A service order may be generated at the beginning of flow 300, with the service order including an advanced execution item. In an example, the service order includes an immediate fixed-price job as well as additional jobs such that the nature of the total job is not fixed-price. Accordingly, there is an initial order value or expected revenue at the beginning of the service order, as well as the expectation that additional items will be added to the job. Also, there may be a principal of agreement for the customer associated with the service order. This principal of agreement may include multiple terms, such as a specific margin (e.g., 10%, 15%) to charge, a discount, and so on.

Based on the initial specification of the service order, a billable maintenance order is generated. This billable maintenance order may include labor costs, spare part costs, and other expenses. Then, during the performance of the job, dynamic items may be added to the billable maintenance order based on the performance of the initial line items of the job. In an example, a health check may be the initial scope of work of the job, and based on the health check, one or more dynamic line items (e.g., calibration, maintenance, repair) may be added to the job. Once the dynamic line items have been completed, a billing request may be generated. The billing request may combine costs associated with the service product, materials, and labor hours. Additionally, the uplift and discounts extracted from the principal of agreement may also be applied to the combined costs to generate a final billable total.

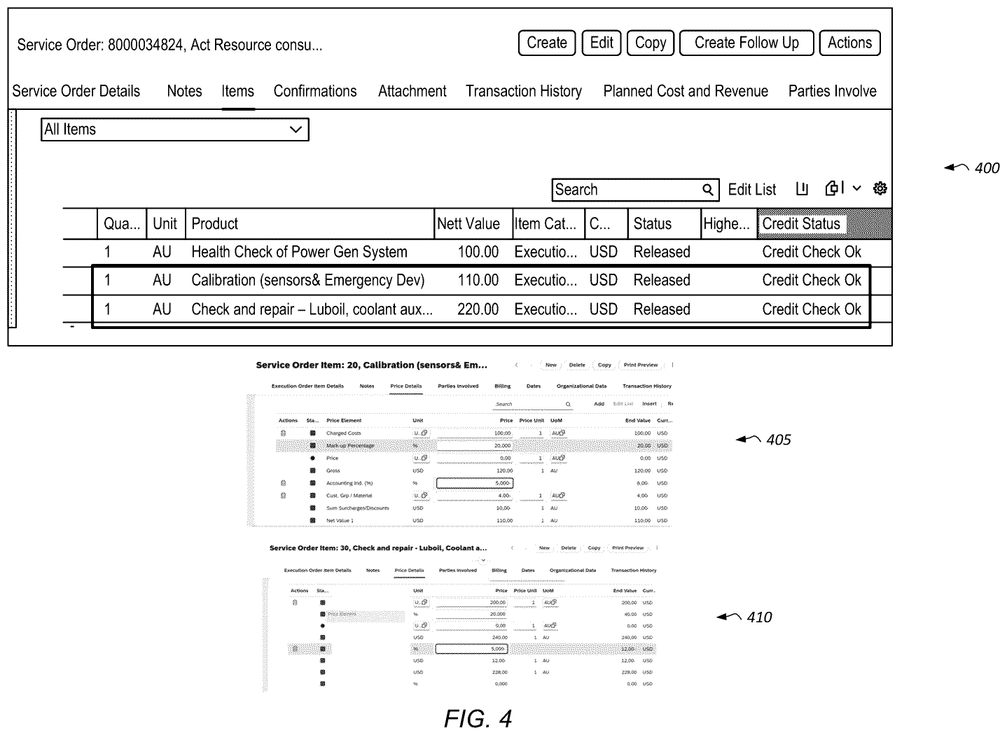

Turning now to FIG. 4, resource-related billing service with advanced execution graphical user interfaces (GUIs) are shown, consistent with implementations of the current subject matter. At the top of FIG. 4, GUI 400 represents an example of a GUI which may be generated to list the items of a service order for one particular example. The first item listed in GUI 400 is a health check of a power generation system. Once the health check is performed, additional items may be added to the service order based on the results of the health check. For the purposes of this discussion, it is assumed that a calibration item and a check and repair item are added to the service order as a result of the health check. As shown on the right column of GUI 400, a credit status indicator may be displayed for each item. This credit status indicator may be generated based on a risk assessment associated with the service order. In the example of GUI 400, the credit status indicator displays “credit check OK” for each of the three items listed in the service order.

In the middle of FIG. 4, GUI 405 illustrates an example of a GUI for displaying the price details associated with the billing value of a calibration item which was added to the service order depicted in GUI 400. GUI 405 also displays the adjustments that are made to the billing value of the calibration item. The calculation of the billing value of the service may involve a plurality of inputs and/or adjustments. For example, the inputs and/or adjustments, as shown in GUI 405, include the charged costs, the mark-up percentage, net price, gross price, accounting discount, customer group discount, total surcharges and/or discounts, and the net value of the item. In other embodiments, other inputs and/or adjustments may be used to generate the billing value of a service order item. At the bottom of FIG. 4, GUI 410 illustrates an example of a GUI for displaying the price details and adjustments associated with the billing value of a check and repair item which was added to the service order depicted in GUI 400. It should be understood that the examples GUIs 400, 405, and 410 are merely illustrative of one particular embodiment. In other embodiments, GUIs may be structured and/or organized in other suitable manners.

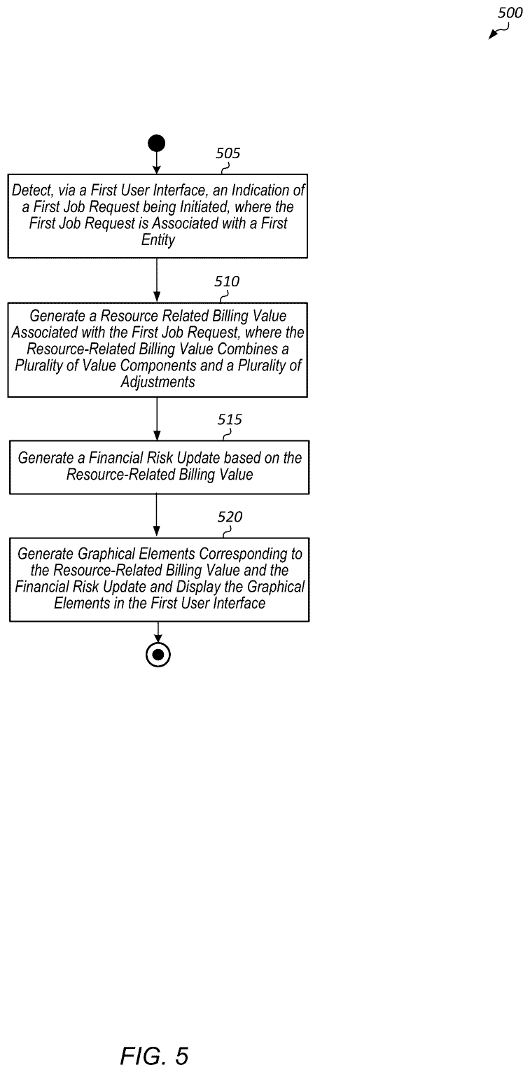

Referring now to FIG. 5, a process for employing a resource related billing advance execution service is shown, in accordance with some example implementations of the current subject matter. A software application detects, via a first user interface, an indication of a first job request being initiated, where the first job request is associated with a first entity (e.g., a first customer, a first organization) (block 505). In response to receiving the first job request, the software application generates a resource related billing value associated with the first job request, where the resource related billing value combines a plurality of value components and a plurality of adjustments (block 510). In an example, the plurality of value components include an individual price agreement for the first job request, a service agreement between the first customer and a service provider, and/or other components. In an example, the plurality of adjustments include a discount, a margin, and so on.

Also in response to receiving the first job request, the software application generates a financial risk update based on the resource-related billing value (block 515). Next, the software application generates graphical elements corresponding to the resource-related billing value and the financial risk update and displays the graphical elements in the first user interface (block 520). After block 520, method 500 ends. It is noted that the software application may generate updated versions of the financial risk update and the resource-related billing value as the job progresses and the scope of work associated with the first job request changes.

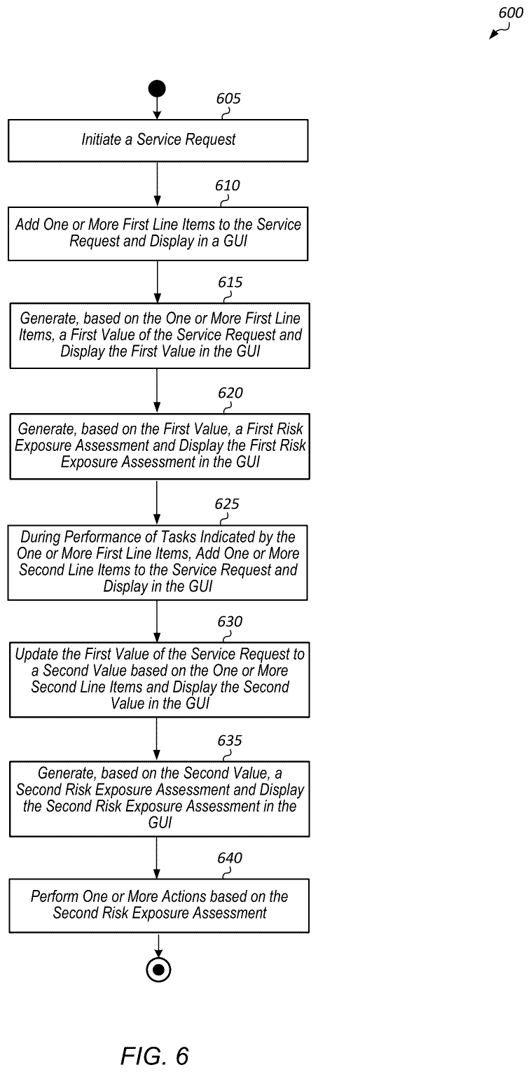

Turning now to FIG. 6, a process for generating multiple risk exposure assessments is shown, in accordance with some example implementations of the current subject matter. At the beginning of method 600, a service request is initiated (block 605). Next, one or more first line items are added to the service request and displayed in a graphical user interface (GUI) (block 610). Then, a first value of the service request is generated based on the one or more first line items and the first value is displayed in the GUI (block 615). It is noted that the first value may also be referred to as a first billing value.

Next, a first risk exposure assessment is generated based on the first value and the first risk exposure assessment is displayed in the GUI (block 620). Then, during performance of tasks indicated by the one or more first line items, one or more second line items are added to the service request and displayed in the GUI (block 625). For example, if the one or more first line items include a health check, the one or more second line items may include a calibration line item and a check and repair line item. Other scenarios may involve other types of follow-on line items being generated based on the initial scope of work being performed for the service request.

Next, the first value of the service request is updated to a second value based on the one or more second line items which are added to the service request and the second value is displayed in the GUI (block 630). Then, a second risk exposure assessment is generated based on the second value, and the second risk exposure assessment is displayed in the GUI (block 635). Next, one or more actions may be performed based on the second risk exposure assessment (block 640). Depending on the embodiment, the one or more actions may include authorizing approval of the service request, pausing the service request until authorization is granted, or rejecting the service request based on the second risk exposure assessment. Indications of the actions that are taken may also be displayed in the GUI. For example, an alert may be generated in the GUI indicating that the service request is not allowed to proceed until appropriate authorization has been obtained. After block 640, method 600 may end.

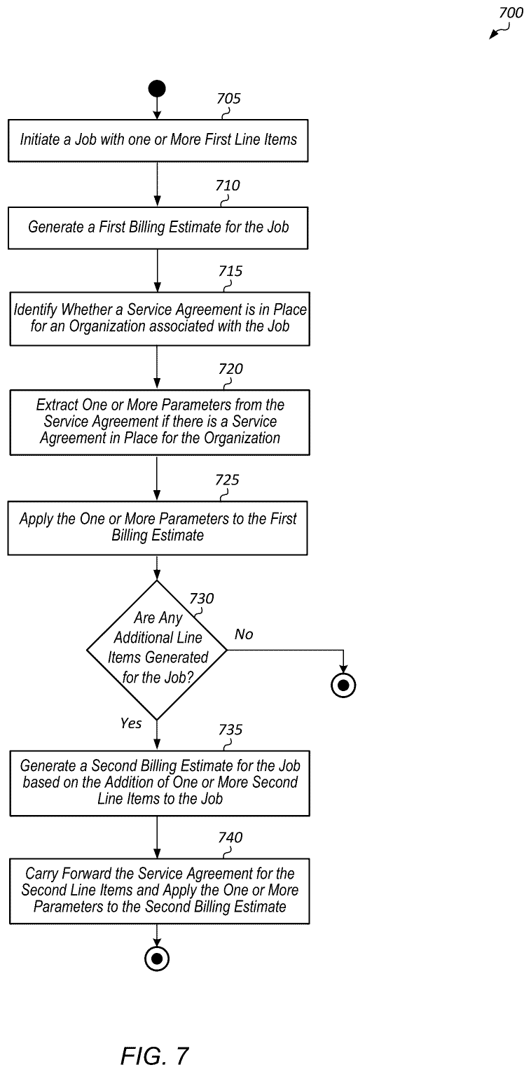

Referring now to FIG. 7, a process for carrying forward a service agreement is shown, in accordance with some example implementations of the current subject matter. At the beginning of method 700, a job is initiated with one or more first line items (block 705). Next, as a result of initiating the job, a software application generates a first billing estimate for the job (block 710). Also, the software application (e.g., software application 135A of FIG. 1) identifies whether a service agreement is in place for an organization associated with the job (block 715). The organization may be a customer, a customer group, a business organization, business affiliate, a non-profit organization, a corporation, a university, an individual, or other entity affiliated with the job. Next, one or more parameters are extracted from the service agreement if there is a service agreement in place for the organization (block 720). The one or more parameters may include a discount, uplift, and/or other values associated with the service agreement.

Then, the one or more parameters are applied to the first billing estimate (block 725). Next, if any additional line items are generated for the job (conditional block 730, “yes” leg), then a second billing estimate is generated for the job based on the addition of one or more second line items to the job (block 735). Next, the service agreement is carried forward for the second line items and the one or more parameters are applied to the second billing estimate (block 740). It is noted that the service agreement may be carried forward and the one or more parameters extracted from the service agreement may be applied for any additional line items that are generated for the job. After block 740, method 700 may end.

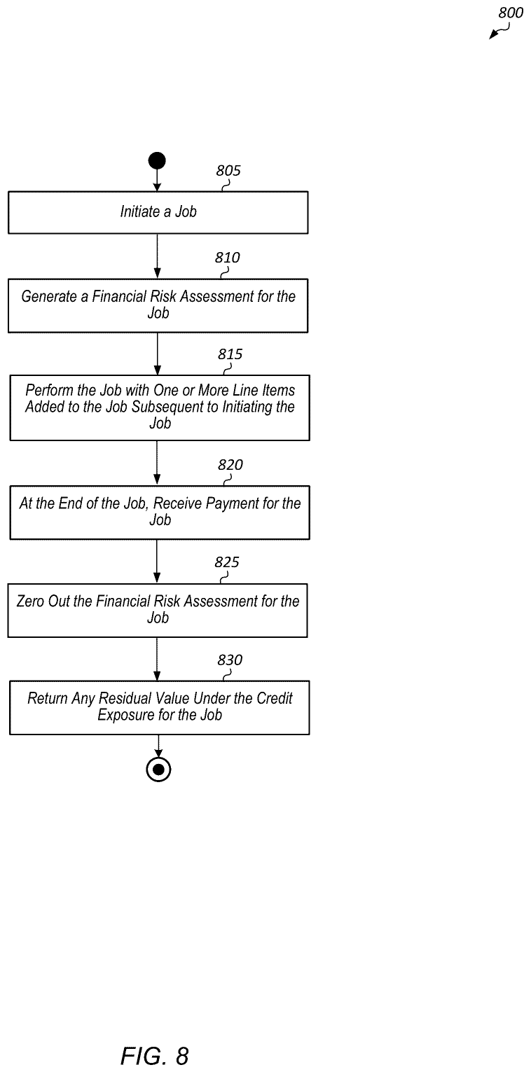

Turning now to FIG. 8, a process for returning residual value after completing a job is shown, in accordance with some example implementations of the current subject matter. At the start of method 800, a job is initiated (block 805). Next, a software application (e.g., software application 135A of FIG. 1) generates a financial risk assessment for the job (block 810). Then, the job is performed with one or more line items added to the job subsequent to initiating the job (block 815). Next, at the end of the job, payment is received for the job (block 820). Then, the software application zeroes out the financial risk assessment for the job (block 825). Next, the software application returns any residual value under the credit exposure for the job (block 830). For example, if the billing estimate for the job was $1000, and the actual billing invoice generated for the job totaled $900, $100 would be the residual value leftover after payment is received for the job. In this example, the $100 of residual value would be returned under the credit exposure for the job. After block 830, method 800 ends.

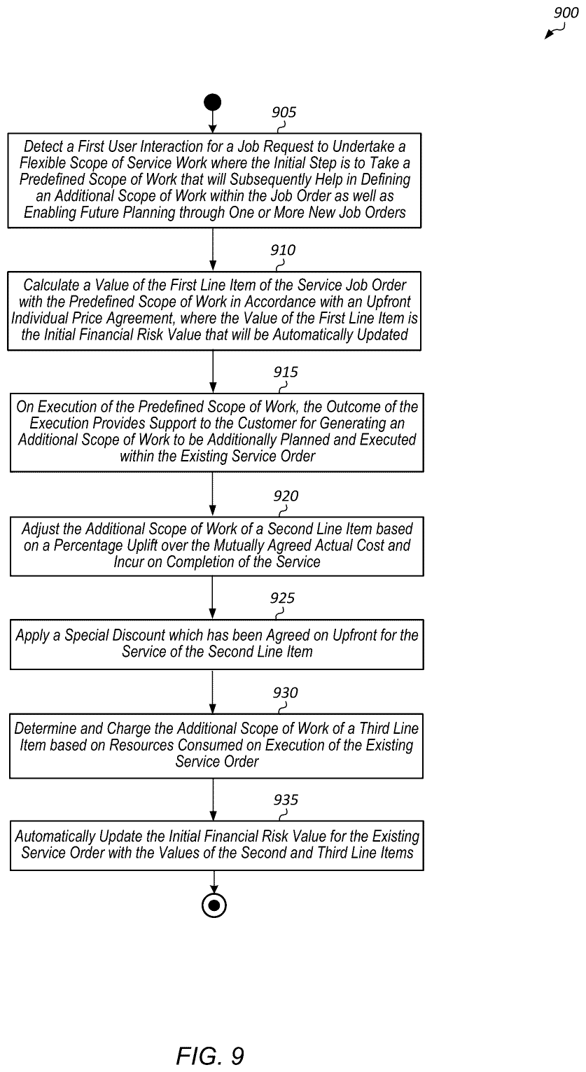

Referring now to FIG. 9, a process for fulfilling a job request with a flexible scope of service work is shown, in accordance with some example implementations of the current subject matter. At the beginning of method 900, a first user interaction is detected for a job request to undertake a flexible scope of service work where the initial step is to take a predefined scope of work that will subsequently help in defining an additional scope of work within the job order as well as enabling future planning through one or more new job orders (block 905). A value of the first line item of the service job order with the predefined scope of work is calculated in accordance with an upfront individual price agreement, where the value of the first line item is the initial financial risk value that will be automatically updated (block 910). On execution of the predefined scope of work, the outcome of the execution provides support to the customer for generating an additional scope of work to be additionally planned and executed within the existing service order (block 915). The additional scope of work of a second line item will be adjusted based on a percentage uplift over the mutually agreed actual cost (i.e., resource consumption-based cost) and will be incurred on completion of the service (block 920). Also, a special discount which has been agreed on upfront will be applied for the service of the second line item (block 925). The additional scope of work of a third line item will be determined and charged based on resources consumed on execution of the existing service order (block 930). The values of the second and third line items will automatically update the initial financial risk value for the existing service order (block 935). After block 935, method 900 may end.

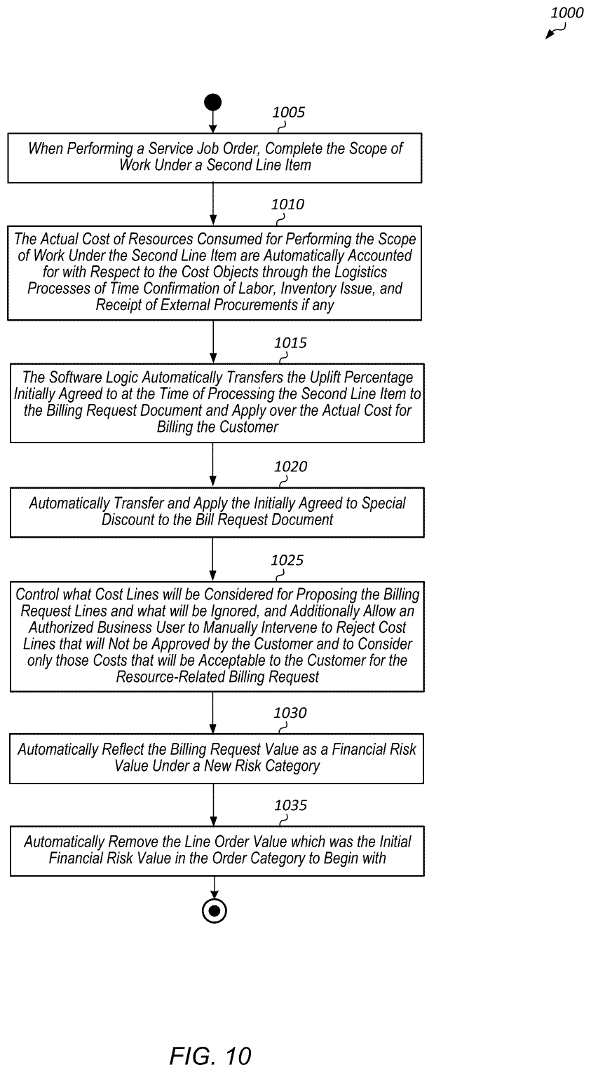

Turning now to FIG. 10, a process for updating a financial risk value when performing a service job order is shown, in accordance with some example implementations of the current subject matter. When performing a service job order, the scope of work under a second line item is completed (block 1005). Typically, there are one or more billable maintenance orders linked to the original second line item of the service job order. Next, the actual cost of the resources (e.g., labor, material, other expenses) for performing the scope of work under the second line item is automatically accounted for with respect to the cost objects through the logistics processes of time confirmation of labor, inventory issue, and receipt of external procurements if any (block 1010). The actual consumption is the source driving the creation of the resource-related billing request. Then, the uplift percentage initially agreed to at the time of processing the second line item will be automatically transferred by the software logic to the billing request document and applied over the actual cost for billing the customer (block 1015). Also, the special discount initially agreed to will be automatically transferred and applied to the bill request document (block 1020). Next, the business configuration will control what cost lines will be considered for proposing the billing request lines and what will be ignored, additionally allowing an authorized business user to manually intervene to reject cost lines that will not be approved by the customer and to consider only those costs that will be acceptable to the customer for the resource-related billing request (block 1025). Then, the billing request value will be automatically reflected as a financial risk value under a new risk category (block 1030). The line order value which was the initial financial risk value in the order category to begin with will be automatically removed (block 1035). After block 1035, method 1000 may end.

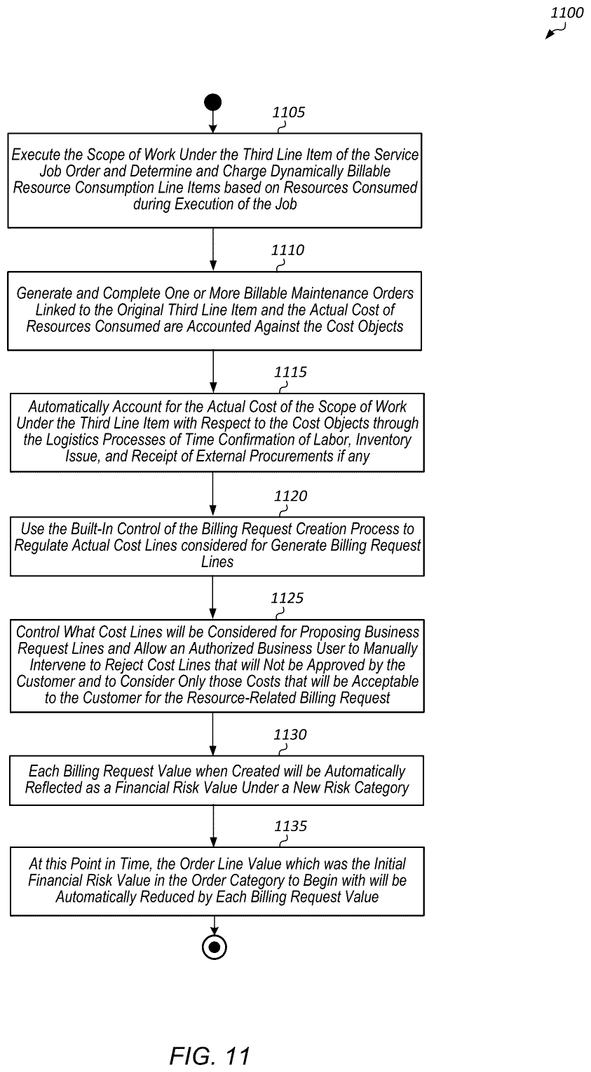

Referring now to FIG. 11, a process for performing the scope of work under the third line item of a service job order is shown, in accordance with some example implementations of the current subject matter. The scope of work under the third line item of the service job order will be executed and dynamically billable resource consumption line items will be determined and charged to the customer based on resources consumed during execution of the job (block 1105). To begin with, the order line value is the expected revenue, since the actual billable value will only be known after consumption cost accounting. This order line value is the initial financial risk value that will be automatically updated. One or more billable maintenance orders linked to the original third line item of the service job order may be generated and completed and the actual cost of resources (e.g., labor, material, other expenses) consumed are accounted against the cost objects (block 1110). Typically, there are one or more billable maintenance orders linked to the original third line item of the service job order. Next, the actual cost of the scope of work under the third line item is automatically accounted for with respect to the cost objects through the logistics processes of time confirmation of labor, inventory issue, and receipt of external procurements if any (block 1115). The actual consumption is the source driving the creation of the resource-related billing request. The billing request creation process has built in control to regulate actual cost lines considered for generating billing request lines (block 1120). This is more relevant for resource related billing of this job item that has significant resource consumption over the duration of the job. Multiple billing requests are envisaged to be created during this execution period of the job. Next, the business configuration will control what cost lines will be considered for proposing the billing request lines and what will be ignored, additionally allowing an authorized business user to manually intervene to reject cost lines that will not be approved by the customer and to consider only those costs that will be acceptable to the customer for the resource-related billing request (block 1125). Each billing request value when created will be automatically reflected as a financial risk value under a new risk category (block 1130). At this point in time, the order line value which was the initial financial risk value in the order category to begin with will be automatically reduced by this value (block 1135). After block 1135, method 1100 may end.

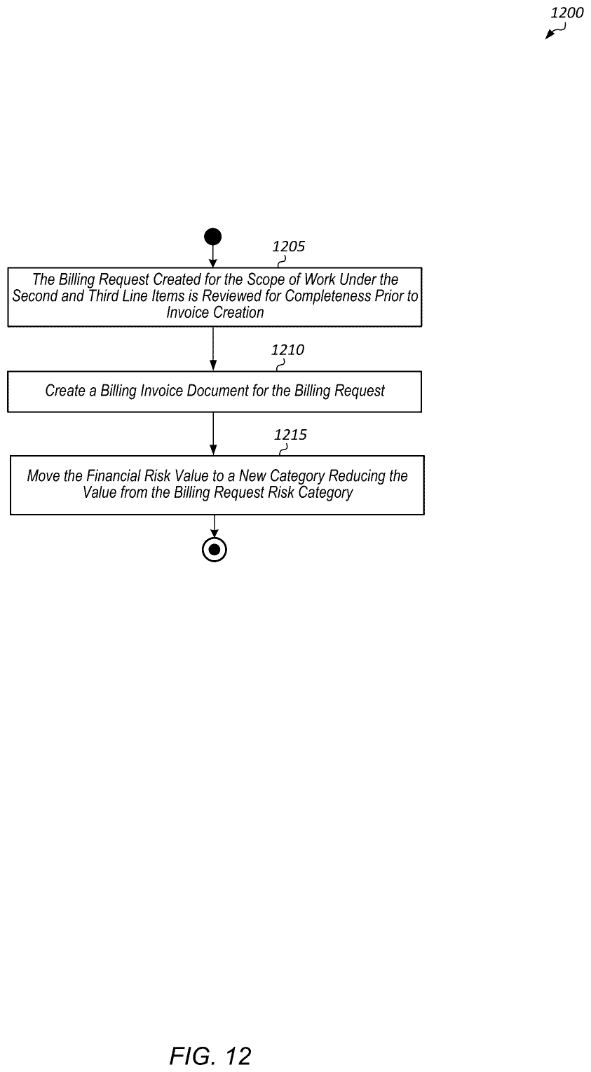

Turning now to FIG. 12, a process for moving a financial risk value to a new category is shown, in accordance with some example implementations of the current subject matter. At the start of method 1200, the billing request created for the scope of work under the second and third line items will be reviewed for completeness prior to invoice creation (block 1205). In an example, the review will ensure a complete description of the services rendered. Next, a billing invoice document is created for the billing request (block 1210). Then, the financial risk value is moved to a new category reducing the value from the billing request risk category (block 1215). After block 1215, method 1200 may end.

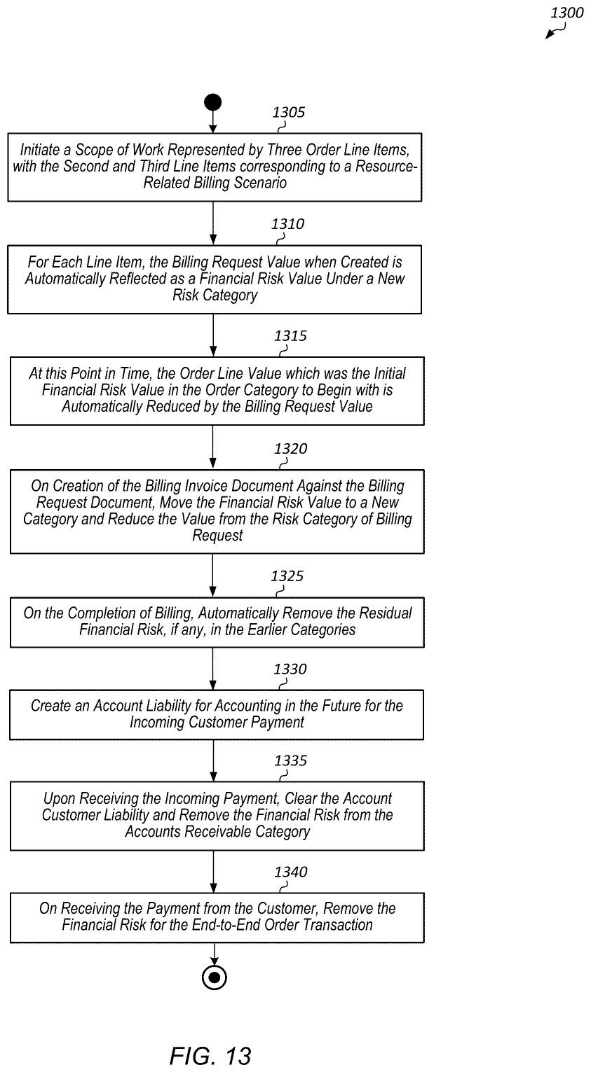

Referring now to FIG. 13, a process for executing a resource-related billing service job order is shown, in accordance with some example implementations of the current subject matter. A scope of work represented by three order line items is initiated, with the second and third line items corresponding to a resource-related billing scenario (block 1305). The order line values are the initial financial risk value that will be automatically updated. For each line item, the billing request value when created will be automatically reflected as a financial risk value under a new risk category (block 1310). At this point in time the order line value which was the initial financial risk value in the order category to begin with will be automatically reduced by this value (block 1315). Next, on creation of the billing invoice document against the billing request document, the financial risk value will move to a new category reducing the value from the risk category of billing request (block 1320). Then, on the completion of billing the residual financial risk in the earlier categories if any will be automatically removed (block 1325). Next, an account liability is created for accounting in the future for the incoming customer payment (block 1330). Upon receiving the incoming payment, the account customer liability is cleared and the financial risk is removed from the accounts receivable category (block 1335). On receiving the payment from customer, the financial risk for the end to end order transaction will be removed (block 1340). After block 1340, method 1300 may end.

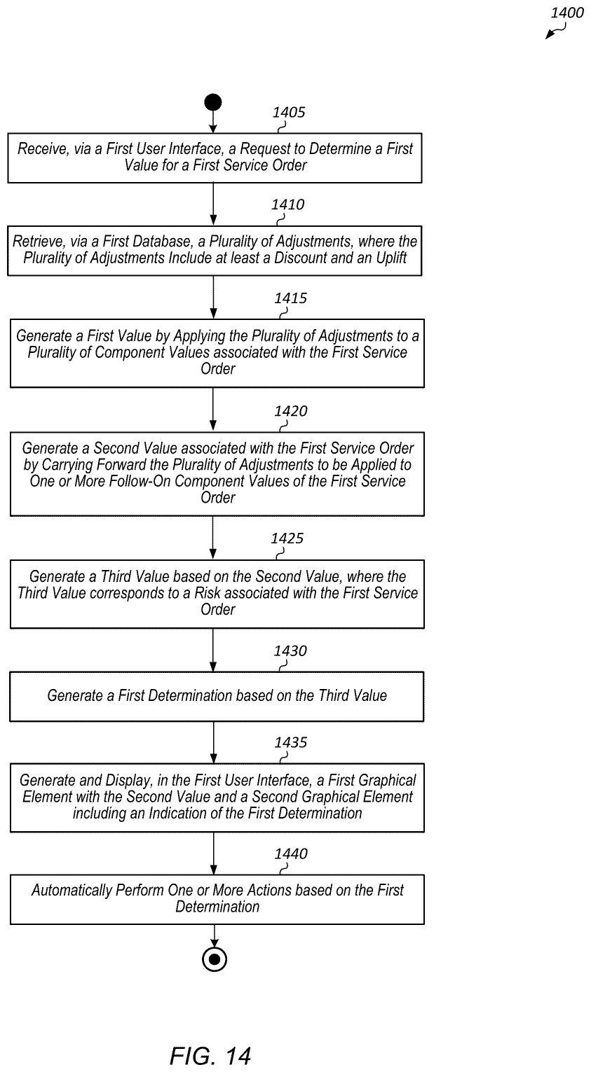

Turning now to FIG. 14, a process for processing a resource-related service order is shown, in accordance with some example implementations of the current subject matter. A request is received, via a first user interface, to determine a first value for a first service order (block 1405). Next, a plurality of adjustments are retrieved via a first database, where the plurality of adjustments include at least a discount and an uplift (block 1410). Then, a first value is generated by applying the plurality of adjustments to a plurality of component values associated with the first service order (block 1415). Next, a second value, associated with the first service order, is generated by carrying forward the plurality of adjustments to be applied to one or more follow-on component values of the first service order (block 1420). Then, a third value is generated based on the second value, where the third value corresponds to a risk associated with the first service order (block 1425). Next, a first determination is generated based on the third value (block 1430). Then, a first graphical element with the second value is generated and displayed in the first user interface and a second graphical element is generated and displayed in the first user interface, where the second graphical element includes an indication of the first determination (block 1435). Also, one or more actions are automatically performed based on the first determination (block 1440). In an example, the one or more actions may include automatically terminating the first service order responsive to the risk being greater than a threshold, generating a third graphical element indicating that the first service order has been terminated responsive to the risk being greater than the threshold, and displaying the third graphical element in the first user interface. In other examples, the one or more actions may include other types of actions. After block 1440, method 1400 may end.

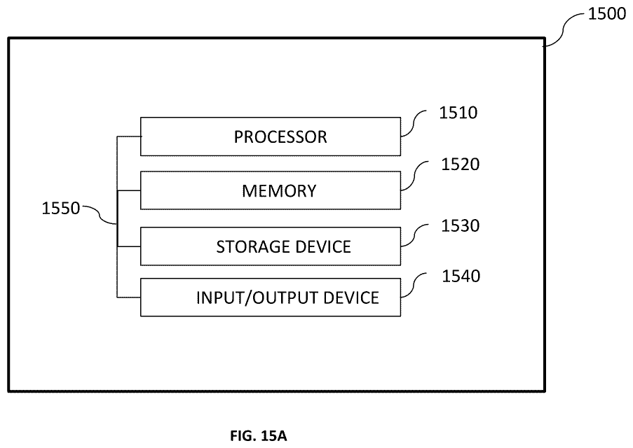

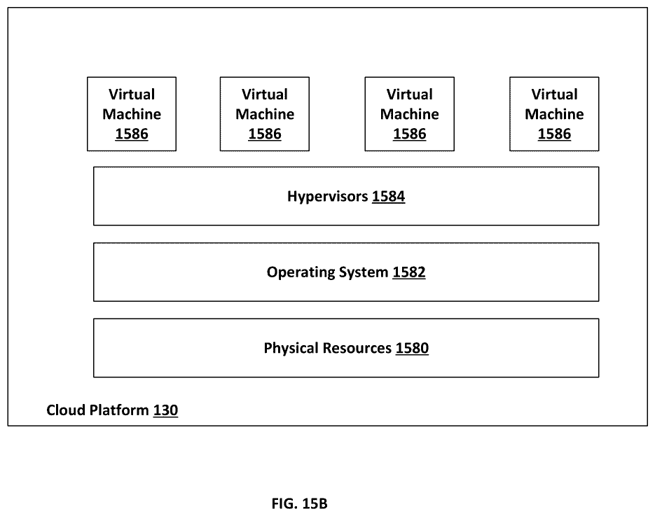

In some implementations, the current subject matter may be configured to be implemented in a system 1500, as shown in FIG. 15A. The system 1500 may include a processor 1510, a memory 1520, a storage device 1530, and an input/output device 1540. Each of the components 1510, 1520, 1530 and 1540 may be interconnected using a system bus 1550. The processor 1510 may be configured to process instructions for execution within the system 1500. In some implementations, the processor 1510 may be a single-threaded processor. In alternate implementations, the processor 1510 may be a multi-threaded processor. The processor 1510 may be further configured to process instructions stored in the memory 1520 or on the storage device 1530, including receiving or sending information through the input/output device 1540. The memory 1520 may store information within the system 1500. In some implementations, the memory 1520 may be a computer-readable medium. In alternate implementations, the memory 1520 may be a volatile memory unit. In yet some implementations, the memory 1520 may be a non-volatile memory unit. The storage device 1530 may be capable of providing mass storage for the system 1500. In some implementations, the storage device 1530 may be a computer-readable medium. In alternate implementations, the storage device 1530 may be a floppy disk device, a hard disk device, an optical disk device, a tape device, non-volatile solid-state memory, or any other type of storage device. The input/output device 1540 may be configured to provide input/output operations for the system 1500. In some implementations, the input/output device 1540 may include a keyboard and/or pointing device. In alternate implementations, the input/output device 1540 may include a display unit for displaying graphical user interfaces.

FIG. 15B depicts an example implementation of a cloud platform 130 (of FIG. 1), which provides cloud services. The cloud platform 130 may be implemented using various physical resources 1580, such as at least one hardware servers, at least one storage, at least one memory, at least one network interface, and the like. The cloud platform 130 may also be implemented using infrastructure, as noted above, which may include at least one operating systems 1582 for the physical resources and at least one hypervisor 1584 (which may create and run at least one virtual machine 1586). For example, each multitenant application may be run on a corresponding virtual machine.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid-state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A method performed by a computing system, comprising: receiving, via a first user interface, a request to determine a first value for a first service order; retrieving, via a first database, a plurality of adjustments, wherein the plurality of adjustments comprise at least a discount and an uplift; generating the first value by applying the plurality of adjustments to a plurality of component values associated with the first service order; generating a second value associated with the first service order by carrying forward the plurality of adjustments to be applied to one or more follow-on component values of the first service order; generating, based on the second value, a third value corresponding to a risk associated with the first service order; generating, based on the third value, a first determination; and displaying, in the first user interface, a first graphical element with the second value and a second graphical element with an indication of the first determination.
Example 2: The method of Example 1, further comprising automatically performing one or more actions based on the first determination.
Example 3: The method of any of Examples 1-2, wherein the one or more actions comprise: automatically terminating the first service order responsive to the risk being greater than a threshold; generating a third graphical element indicating that the first service order has been terminated responsive to the risk being greater than the threshold; and displaying the third graphical element in the first user interface.
Example 4: The method of any of Examples 1-3, wherein the plurality of component values further comprise an immediate component.
Example 5: The method of any of Examples 1-4, wherein the immediate component is determined based on an individual agreement for the first service order.
Example 6: The method of any of Examples 1-5, further comprising determining the plurality of adjustments from a first service agreement between a first customer and a service provider.
Example 7: The method of any of Examples 1-6, further comprising: determining the risk associated with the first service order based at least on one or more risk-related component values associated with the first service order; and generating and displaying, via the first user interface, a third graphical element indicating how to manage the risk.
Example 8: The method of any of Examples 1-7, wherein the third graphical element includes an indication that approval is required for the first service order based on the risk.
Example 9: The method of any of Examples 1-8, wherein the third graphical element includes an indication that the first service order is automatically approved based on the risk.
Example 10: A system comprising: at least one processor; and at least one memory storing instructions that, when executed by the at least one processor, cause operations comprising: receiving, via a first user interface, a request to determine a first value for a first service order; retrieving, via a first database, a plurality of adjustments, wherein the plurality of adjustments comprise at least a discount and an uplift; generating the first value by applying the plurality of adjustments to a plurality of component values associated with the first service order; generating a second value associated with the first service order by carrying forward the plurality of adjustments to be applied to one or more follow-on component values of the first service order; generating, based on the second value, a third value corresponding to a risk associated with the first service order; generating, based on the third value, a first determination; and displaying, in the first user interface, a first graphical element with the second value and a second graphical element with an indication of the first determination.
Example 11: The system of Example 10, wherein the operations further comprise automatically performing one or more actions based on the first determination.
Example 12: The system of any of Examples 10-11, wherein the operations further comprise: automatically terminating the first service order responsive to the risk being greater than a threshold; generating a third graphical element indicating that the first service order has been terminated responsive to the risk being greater than the threshold; and displaying the third graphical element in the first user interface.
Example 13: A The system of any of Examples 10-12, wherein the plurality of component values further comprise an immediate component.
Example 14: The system of any of Example 10-13, wherein the immediate component is determined based on an individual agreement for the first service order.
Example 15: The system of any of Examples 10-14, wherein the operations further comprise determining the plurality of adjustments from a first service agreement between a first customer and a service provider.
Example 16: The system of any of Examples 10-15, wherein the operations further comprise: determining the risk associated with the first service order based at least on one or more risk-related component values associated with the first service order; and generating and displaying, via the first user interface, a third graphical element indicating how to manage the risk.
Example 17: The system of any of Examples 10-16, wherein the third graphical element includes an indication that approval is required for the first service order based on the risk.
Example 18: The system of any of Examples 10-17, wherein the third graphical element includes an indication that the first service order is automatically approved based on the risk.
Example 19: A non-transitory computer readable medium storing instructions, which when executed by at least one data processor, result in operations comprising: receiving, via a first user interface, a request to determine a first value for a first service order; retrieving, via a first database, a plurality of adjustments, wherein the plurality of adjustments comprise at least a discount and an uplift; generating the first value by applying the plurality of adjustments to a plurality of component values associated with the first service order; generating a second value associated with the first service order by carrying forward the plurality of adjustments to be applied to one or more follow-on component values of the first service order; generating, based on the second value, a third value corresponding to a risk associated with the first service order; generating, based on the third value, a first determination; and displaying, in the first user interface, a first graphical element with the second value and a second graphical element with an indication of the first determination.
Example 20: The non-transitory computer readable medium of Example 19, wherein the operations further comprise: automatically terminating the first service order responsive to the risk being greater than a threshold; generating a third graphical element indicating that the first service order has been terminated responsive to the risk being greater than the threshold; and displaying the third graphical element in the first user interface.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A method performed by a computing system, comprising:
receiving, via a first user interface, a request to determine a first value for a first service order;
retrieving, via a first database, a plurality of adjustments, wherein the plurality of adjustments comprise at least a discount and an uplift;
generating the first value by applying the plurality of adjustments to a plurality of component values associated with the first service order;
generating a second value associated with the first service order by carrying forward the plurality of adjustments to be applied to one or more follow-on component values of the first service order;
generating, based on the second value, a third value corresponding to a risk associated with the first service order;
automatically authorizing the first service order in response to the third value being less than a risk threshold; and
displaying, in the first user interface, a first graphical element with the second value and a second graphical element with an indication of the automatic authorization of the first service order.

2. (canceled)

3. (canceled)

4. The method of claim 1, wherein the plurality of component values further comprise an immediate component.

5. The method of claim 4, wherein the immediate component is determined based on an individual agreement for the first service order.

6. The method of claim 5, further comprising determining the plurality of adjustments from a first service agreement between a first customer and a service provider.

7. The method of claim 1, further comprising:
determining the risk associated with the first service order based at least on one or more risk-related component values associated with the first service order; and
generating and displaying, via the first user interface, a third graphical element indicating how to manage the risk.

8. The method of claim 7, wherein the third graphical element includes an indication that approval is required for the first service order based on the risk.

9. The method of claim 7, wherein the third graphical element includes an indication that the first service order is automatically approved based on the risk.

10. A system comprising:
at least one processor; and
at least one memory storing instructions that, when executed by the at least one processor, cause operations comprising:
receiving, via a first user interface, a request to determine a first value for a first service order;
retrieving, via a first database, a plurality of adjustments, wherein the plurality of adjustments comprise at least a discount and an uplift;
generating the first value by applying the plurality of adjustments to a plurality of component values associated with the first service order;
generating a second value associated with the first service order by carrying forward the plurality of adjustments to be applied to one or more follow-on components of the first service order;
generating, based on the second value, a third value corresponding to a risk associated with the first service order;
automatically authorizing the first service order in response to the third value being less than a risk threshold; and
displaying, in the first user interface, a first graphical element with the first value and a second graphical element with an indication of the automatic authorization of the first service order.

11. (canceled)

12. (canceled)

13. The system of claim 10, wherein the plurality of component values further comprise an immediate component.

14. The system of claim 13, wherein the immediate component is determined based on an individual agreement for the first service order.

15. The system of claim 14, wherein the operations further comprise determining the plurality of adjustments from a first service agreement between a first customer and a service provider.

16. The system of claim 10, wherein the operations further comprise:
determining the risk associated with the first service order based at least on one or more risk-related components associated with the first service order; and
generating and displaying, via the first user interface, a third graphical element indicating how to manage the risk.

17. The system of claim 16, wherein the third graphical element includes an indication that approval is required for the first service order based on the risk.

18. The system of claim 16, wherein the third graphical element includes an indication that the first service order is automatically approved based on the risk.

19. A non-transitory computer readable medium storing instructions, which when executed by at least one data processor, result in operations comprising:
receiving, via a first user interface, a request to determine a first value for a first service order;
retrieving, via a first database, a plurality of adjustments, wherein the plurality of adjustments comprise at least a discount and an uplift;
generating the first value by applying the plurality of adjustments to a plurality of component values associated with the first service order;
generating a second value associated with the first service order by carrying forward the plurality of adjustments to be applied to one or more follow-on components of the first service order;
generating, based on the second value, a third value corresponding to a risk associated with the first service order;
automatically authorizing the first service order in response to the third value being less than a risk threshold; and
displaying, in the first user interface, a first graphical element with the first value and a second graphical element with an indication of the automatic authorization of the first service order.

20. (canceled)
